(19) United States
(12) Patent Application Publication
(10) Pub. No.: US 2017/0330159 A1
(43) Pub. Date: Nov. 16, 2017

(54) RESOURCE ALLOCATION AND TRANSFER IN A DISTRIBUTED NETWORK

(71) Applicant: Bank of America Corporation, Charlotte, NC (US)

(72) Inventors: Joseph Benjamin Castinado, North Glenn, CO (US); James Gregory Ronca, Decatur, GA (US); Richard Huw Thomas, Charlotte, NC (US)

(21) Appl. No.: 15/154,479

(22) Filed: May 13, 2016

(51) Int. Cl. G06Q 20/02; G06Q 20/36; H04L 29/08

(52) U.S. Cl. CPC G06Q 20/02; H04L 67/327; G06Q 20/36; H04L 67/025

(57) ABSTRACT

The custodial block chain network is a distributed network of systems, including at least a first entity system, a second entity system, and a custodian entity system, wherein the network allows the first entity to quickly, securely, and easily allocate resources associated with a first user, via an electronic contract stored in the block chain, from the first entity to a second user associated with a second entity. The custodian entity system provides, through the use of the network, resource pools for the first and the second entities, and holds allocated resources from the first entity system until acceptance of the electronic contract. Upon acceptance of the electronic contract, the resources are released by the custodian entity to the resource pool associated with the second entity allowing the second entity to provide the allocated resources to the second user.

### FIELD

The present invention relates to utilizing a distributed network and block chain for facilitating an allocation of resources. More particularly, the present invention relates to using a custodian entity to act as a third party arbitrator between two or more entities involved in the allocation resources through the use of a block chain.

### BACKGROUND

Resource allocation between users belonging to different institutions can be a complicated process. Additionally, utilizing a block chain for allocating resources may make the process more complicated. Accordingly, there exists a need to facilitate the allocation of resources between users of two more entities through the use of one or more block chains.

### BRIEF SUMMARY

Embodiments of the present invention address these and/or other needs by providing an innovative system, method and computer program product for completing allocation of resources between users through the use of one or more block chains by utilizing a custodian entity to act as a third party to hold the resources and facilitate the allocation between multiple entities. Additionally, users are not directly involved in the allocation of resources by the third party, but instead are represented by the entities associated with each user, and in some cases represented anonymously to provide additional security.

The custodial block chain network comprises at least a first entity, a second entity, and a custodian entity, wherein the network allows the first entity to quickly, securely, and easily allocate resources associated with a first user, via a contract, from the first entity to a second user associated with a second entity. It should be understood that multiple entities may be associated within the custodial block chain in order to allocate resources between multiple entities, as needed. It should be understood that the resources associated with the users are not directly allocated by a first entity to a second entity, but instead a custodian entity is utilized to act as an independent party to facilitate the allocation and maintain the record of the allocation in a block chain. The resources being allocated from the first user to the second user may undergo off block chain processing within the first entity and/or second entity in order to satisfy reconciliation between the source entity and the target entity. Within the off chain processing the resources may be secured or transferred to the users through holding resource pools to provide additional security and/or reconciliation between the entities. Both the first and the second entity maintain and periodically replenish resource pools within a third party custodian entity on the block chain who acts as an arbitrator for the allocation of resources by temporarily holding the allocated resources from the first entity while a contract for the allocation is accepted by both the first and the second entity. Upon acceptance of the contract, the resources are released by the custodian entity to the resource pool associated with the second entity allowing the second entity to provide the allocated resource to the second user, in some cases through a holding resource pool created by the second entity, thus completing the allocation.

Embodiments of the invention includes systems, methods, and computer program products for facilitating electronic resource allocation between a first user associated with a source entity and a second user associated with a target entity through a custodian entity using a custodian block chain network. The invention includes electronically receiving a request from the source entity system through the custodian block chain network to allocate resources from the first user to the second user. The invention also includes electronically creating an electronic contract through the custodian block chain network to allocate the resources from the source entity to the target entity. Thereafter the invention includes electronically storing the contract on a block chain through the custodian block chain network. The invention further includes electronically allocating the resources from a source entity wallet owned by the source entity and held by the custodian entity on a custodian entity system to a custodian wallet through the custodian block chain network. The invention includes electronically assigning the resources in the custodian wallet to the contract through the custodian block chain network. The invention includes electronically storing the assignment of the resources to the contract on the block chain through the custodian block chain network. Furthermore, the invention includes electronically receiving confirmation that the contract is accepted by the target entity through the target entity systems and the source entity system through the source entity system through the custodian block chain network. The invention also includes electronically storing the acceptance of the contract in the block chain through the custodian block chain network. The invention electronically releases the resources from the custodian wallet to the target entity through the block chain network when the contract is accepted; and electronically stores a completion of the contract and resource allocation information regarding the contract in the block chain through the block chain network.

In further accord with embodiments of the invention, the request is created by electronically receiving the request from a first user through a first user device to allocate the resources from a first user resource pool to a second user resource pool of the second user at the second entity; electronically determining from the request, the block chain and the custodian entity through which the request should be processed; electronically creating a source entity holding resource pool that is linked with the first user resource pool and the source entity wallet held by the custodian entity; electronically securing the resources from the first user resource pool; electronically allocating the resources from the first user resource pool to the source entity holding resource pool; and wherein the resources in the source entity holding resource pool is designated for the source wallet held by the custodian resource pool.

In other embodiments of the invention, releasing the resources from the custodian wallet to the target entity comprises releasing the resources to a target entity wallet linked with the target entity.

In yet other embodiments, the invention further comprises electronically notifying the target entity of the contract, wherein upon acceptance of the contract by the target entity electronically create a target entity holding resource pool that is linked with a second user resource pool and the target entity wallet held by the custodian entity; electronically receiving the resources from the custodian entity wallet in the target entity wallet; electronically allocating the resources from the target entity wallet to the target entity holding resource pool, and wherein the resources in the target entity holding resource pool are designated for the second user resource pool at the target entity.

In still another embodiments, the invention comprises electronically notifying the target entity of the contract, and wherein upon acceptance of the contract by the target entity reconcile the allocation of the resources between the target entity wallet and the second user resource pool at the second entity.

In yet other embodiments, the invention comprises identifying the source entity and the target entity; accessing an authorization list with authorized entities; determining if the source entity and the target entity are authorized entities; and validating the contract.

In further accord with embodiments, the invention comprises electronically changing a contract status of the contract when the contract is created, when the source entity or the target entity are validated, when the resources are assigned by the custodian entity to the contract, when the contract is accepted by the source entity or the target entity, when the resources have been allocated from the source entity to the custodian wallet resource pool or the target wallet resource pool, or when the contract and resource allocation have been validated on the block chain.

In other embodiments of the invention, the source entity is a source financial institution, the target entity is a target financial institution, and the custodian entity is an entity financial institution, a federal reserve entity, or a specialized entity configured to hold the wallet resource pools.

In yet other embodiments, the invention comprises electronically monitoring the source wallet resource pool or the target wallet resource pool; determining when resources in the source wallet resource pool or the target wallet resource pool fall below a lower resource amount or increase above an upper resource amount; electronically transfer new resources to the source wallet resource pool or the target wallet resource pool when the resources fall below the lower resource amount; and electronically withdrawal a portion of the resources from the source wallet resource pool or the target wallet resource pool when the resources are increased above the upper resource amount.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 presents a block diagram illustrating a custodial block chain system environment, in accordance with aspects of the invention;

FIG. 2 presents a block diagram illustrating a decentralized block chain network configuration, in accordance with aspects of the invention;

FIG. 3 presents a flow diagram for completing an allocation of resources between entities through a custodial block chain network, in accordance with aspects of the invention; and

FIG. 4 presents a flow diagram for off block chain processing carried out by an entity, in accordance with aspects of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Embodiments of the present invention provide utilizing a custodian entity to facilitate an allocation of resources (otherwise described herein as a resource allocation, resource transfer, or transfer of resources) between a first user associated with a source entity and a second user associated with a target entity within a block chain network. In the present invention, a contract is created by the custodian entity to facilitate the resource allocation, and a block chain may be used to create, stored, and validate the contract. In order to facilitate the resource allocation process and ensure the security of the resources and/or information in the contract, a third party entity act as a custodian or arbitrator (e.g., custodian entity) and mediates the contract by temporarily holding the resources associated with the allocation in a pool while the contract is agreed upon by the entities. The source and target entity act as representatives for the first and second users respectively and provide or receive the allocation of resources as required by the contract on the block chain network via resource pools held by the source and target entities by custodian entity, as well as in some embodiments a resource pool held by the custodian entity. The resource pools are funded by the source and target entities. In this way, the first and second users do not interact with the custodian and/or the entities associated with the opposing user, but instead, place or receive resources on or from an internal holding pool maintained by the entity associated with the corresponding user outside of the block chain. In some embodiments resources may undergo off chain processing such as resources type conversion within an entity removed from the block chain. The resources held by the custodian entity are released to the target entity for the benefit of the second user. In some embodiments, the target entity receiving the resources may allocate the resources to the second user resource pool of the second user before the system signals the source entity that the allocation was successfully completed.

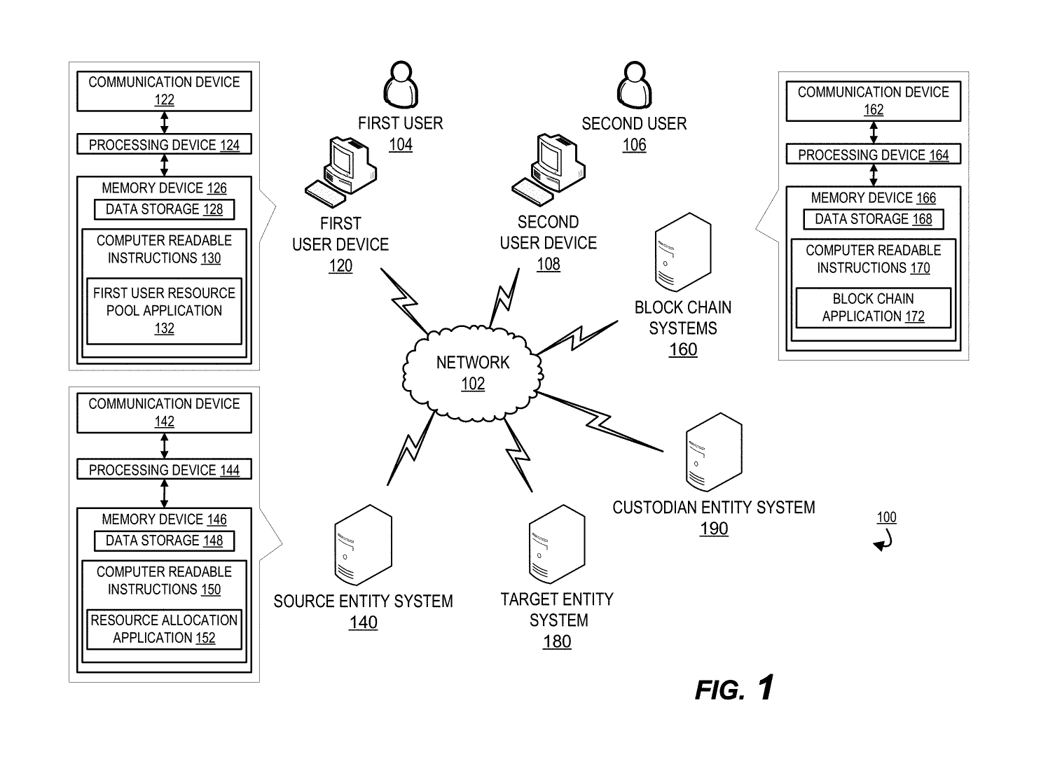

FIG. 1 illustrates a custodial block chain system environment 100, in accordance with embodiments of the invention. As illustrated in FIG. 1, the environment 100 includes a first user 104 associated with a source entity and a second user 106 associated with a target entity. A user of the system may be a person, but may also be another entity, such as a business (e.g., a merchant) or any other type of entity which may allocate resources between entities and/or individuals.

As illustrated in FIG. 1, the first user device 120 is operatively coupled to the source entity system 140, which is operatively coupled to the custodian entity system and/or block chain systems 160, which is then operatively coupled to the target entity system 180 which is operatively coupled to the second user device 108, as will be described in detail throughout this application. It should be understood these devices and systems may be directly or indirectly operatively coupled together depending on the communication occurring between the devices and systems.

As illustrated in FIG. 1, one or more block chain systems 160 are operatively coupled, via a network 102, to a source entity system 140, a target entity system 180, a custodian entity system 190, or other like systems. In this way, outside or inside representative (e.g., one or more associates, employees, agents, contractors, sub-contractors, third-party representatives, individuals, or the like) associated with the entities may allocate resources between the entities and/or users using a block chain through the one or more block chain systems 160 and/or entity systems 140, 180, 190 within the custodial block chain system environment 100. The block chain systems 160 may be utilized to allow a first user 104 through a first user device 120 to allocate resources associated with an event to a second user 106 over the custodian block chain system environment 100. It should be understood that the custodian block chain system environment 100 may be otherwise described as a distributed network of systems over which the resource allocation takes place.

The network 102 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the block chain systems 160 generally comprise a communication device 162, a processing device 164, and a memory device 166. The processing device 164 is operatively coupled to the communication device 162 and the memory device 166. As used herein, the term “processing device” or “processor” generally includes circuitry used for implementing the communication and/or logic functions of a particular system. For example, a processing device 164 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The processing device 164 may include functionality to operate one or more software programs based on computer-readable instructions 170 thereof, which may be stored in the memory device 166.

The processing device 164 uses the communication device 166 to communicate with the network 102 and other devices on the network 102, such as, but not limited to, the source entity system 140, the target entity system 180, the custodian entity system 190, or other like systems (or in some cases first user device 120 or the second user device 108). However, in some embodiments it should be understood that the block chain systems 160 may only be controlled by the custodian entity system 190 in order to facilitate the resource allocation described herein. Alternatively, in other embodiments the block chain system 160 may be controlled by all of the entities 140, 180, 190 within the custodial block chain system environment 100 in order to allow for resource allocation between the various entities associated with the custodial block chain system environment 100, which are facilitated by the custodian entity system 190. In other embodiments the block chain systems 160 may be controlled by an outside entity that is not the source entity, target entity, and/or the custodian entity. Regardless of the entity controlling the block chain, the one or more entities (e.g., source entity, target entity, and/or custodian entity) may be able to access the information stored by the block chain system 160, such as but not limited to the information in the contract, or other resource allocation information. The various entities may have access to the block chain systems 160 in order to store and/or view stored records related to the resource allocation. As such, the communication device 162 generally comprise a wireless transceiver, modem, server, electrical connection, electrical circuit, or other component for electronically communicating with other components on the network 102. The communication device 162 may further include an interface that accepts one or more network interface cards, ports for connection of network components, Universal Serial Bus (USB) connectors, and/or the like.

As further illustrated in FIG. 1, the block chain systems 160 comprise computer-readable instructions 170 stored in the memory device 166, which in one embodiment includes the computer-readable instructions 170 of the block chain application 172. In some embodiments, the memory device 166 includes data storage 168 for storing data related to the block chain systems 160, including, but not limited to, data created, accessed, and/or used by the block chain application 172. As explained in further detail later the block chain systems 10, or a portion thereof may be located in or associated with the other systems described herein, such as the source entity system 140, the target entity system 180, and/or the custodian entity system 190.

As illustrated in FIG. 1, a first user 104 may access the source entity system 140, through the first user device 120. The first user device 120 may be a desktop, laptop, tablet, mobile device (e.g., smartphone device, or other mobile device), or any other type of computer that generally comprises a communication device 122, a processing device 124, and a memory device 126. The first user 104 may access the source entity system 140 to allocate resources associated with an event to the second user 106.

The processing device 124 of the first user device 120 is operatively coupled to the communication device 122, and the memory device 126. The processing device 124 uses the communication device 122 to communicate with the network 102 and other devices on the network 102, such as, but not limited to, the source entity system 140, the target entity system 180, the custodian entity system 190, the second user device 108, or other systems. However, in some aspects of the invention the first user device 120 may only interface with the source entity system 140, which then interfaces with the other systems, as described herein. As such, the communication device 122 generally comprises a wireless transceiver, modem, server, electrical connection, or other component for electronically communicating with other devices on the network 102. The communication device 122 may further include an interface that accepts one or more network interface cards, ports for connection of network components, Universal Serial Bus (USB) connectors, and/or the like. Moreover, the communication device 122 may include a keypad, keyboard, touch-screen, touchpad, microphone, mouse, joystick, other pointer component, button, soft key, and/or other input/output component(s) for communicating with the first user 104.

As illustrated in FIG. 1, the first user device 120 may have computer-readable instructions 130 stored in the memory device 126, which in one embodiment includes the computer-readable instructions 130 of a first user resource pool application 132. In some embodiments, the first user resource pool application 132 allows the first user 104 to manage a resource pool associated with the source entity institution 140 via the first user device 120.

The second user device 108 is associated with the second user 106 as illustrated in FIG. 1. It should be understood that the second user device 108 is comprised of the same or similar devices to those contained in the first user device 120 (e.g., a communication device, a processing device, and a memory device with computer-readable instructions of a resource pool application, data storage, or the like), and operates in the same or similar way, with respect to the systems described herein, and in particular the target entity system 180.

Also illustrated in FIG. 1, the source entity system 140 generally comprises a communication device 142, a processing device 144, and a memory device 146. The processing device 144 is operatively coupled to the communication device 142 and the memory device 146. The processing device 144 uses the communication device 146 to communicate with the network 102 and other devices on the network 102, such as, but not limited to, the first user device 120, the second user device 108, the target entity system 180, the custodian entity system 190, the block chain systems 160, or other like systems. However, in some aspects of the invention the source entity system 140 may only interface with the custodian entity system 190 (and potentially the block chain systems 160), which then interfaces with the other systems, such as the block chain systems 160 and/or the target entity systems 180, as described herein. As such, the communication device 142 generally comprise a wireless transceiver, modem, server, electrical connection, electrical circuit, or other component for electronically communicating with other devices on the network 102. The communication device 142 may further include an interface that accepts one or more network interface cards, ports for connection of network components, Universal Serial Bus (USB) connectors, and/or the like.

As further illustrated in FIG. 1, the source entity system 140 comprises computer-readable instructions 150 stored in the memory device 146, which in one embodiment includes the computer-readable instructions 150 of the resource allocation application 152. In some embodiments, the resource allocation application 152 allows the source entity system 140 to allocate resources internally and/or through a custodian entity system 190 and/or block chain systems 160 to the target entity system 180, or other entity systems. In some embodiments, the memory device 146 includes data storage 148 for storing data related to the source entity system 140, including, but not limited to, data created, accessed, and/or used by the resource allocation application 152.

The target entity system 180 is associated with the second user 106. It should be understood that the target entity system 180 is comprised of the same or similar devices to those contained in the source entity system 140 (e.g., a communication device, a processing device, and a memory device with computer-readable instructions of a transfer application, data storage, or the like), and operates in the same or similar way, with respect to the systems described herein, and in particular the custodian entity system 190 and/or block chain systems 160. As such, the target entity system 180 interfaces with the custodian entity system 190 (and potentially the block chain systems 160), which then interfaces with the source entity system 140 in order to receive the allocation of resources from the source entity system 140, as will be described in further detail herein.

Moreover, the custodian entity system 190 is comprised of the same or similar devices to those contained in the source entity system 140 and/or the target entity system 180 (e.g., a communication device, a processing device, and a memory device with computer-readable instructions of a transfer application, data storage, or the like), and operates in the same or similar way, with respect to the systems described herein, and in particular the source entity system 140 and/or the target entity system 180. As such, the custodian entity system 190 interfaces with the source entity system 140, the target entity system 180, and/or the block chain systems 160 in order to facilitate the allocation of resources from the source entity system 140 to the target entity systems using a block chain, as will be described in further detail throughout this disclosure.

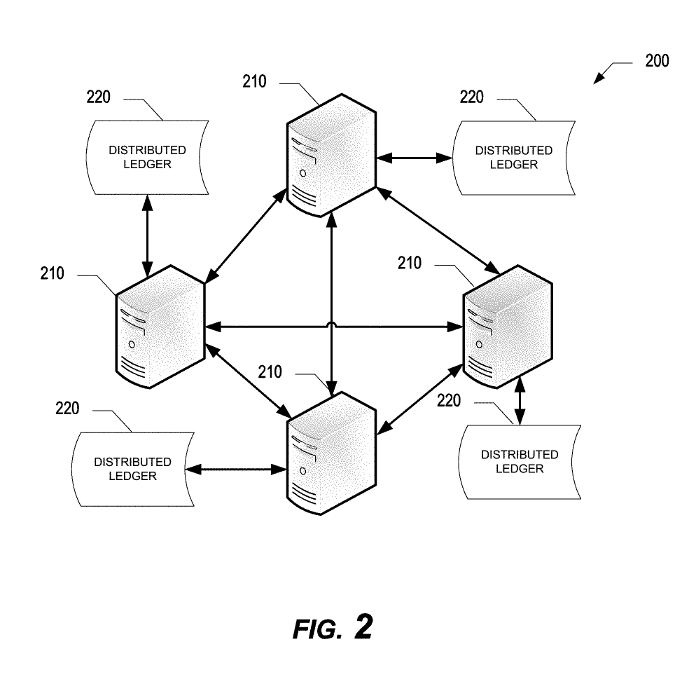

FIG. 2 provides a block chain system diagram, illustrating how a block chain operates. Rather than utilizing a centralized database to access, view, store, disseminate, and/or validate information, the present invention utilizes a decentralized block chain configuration or architecture, as shown in FIG. 2 in one aspect of the invention. The decentralized block chain allows users to access, view, store, disseminate, and/or validate information, or take another action related to an event (e.g., resource allocation, or the like). Such a decentralized block chain configuration ensures accurate mapping and validation of event information, and provides a secured network over which information may be validated. Accordingly, block chain configurations may be utilized with respect to any type of information, such as, but not limited to maintaining an accurate ledger of information, such as resource allocation information (e.g., transaction, asset transfer, sale, or other like transfer of value and/or information), personal information, credit history information, or the like, in order to provide validation, such as validation of resource allocation, or access to personal information, or the like.

A block chain (otherwise described herein as a “blockchain”) is a distributed database that maintains a list of data records, the security of which is enhanced by the distributed nature of the block chain. A block chain typically includes several nodes, which may be one or more entities, systems within an entity, machines, computers, databases, data stores, or the like operably connected with one another. For example, the various systems and devices (or at least some of the systems and devices, such as the source entity system 140, target entity system 180, or custodian entity system 190) described with respect to FIG. 1, or systems within the systems and devices described with respect to FIG. 1 (e.g., various systems within the custodian entity system 190, or other entity systems) may be nodes. In some aspects of the invention, an entity may be a node of a block chain, and internal or external block chain users (e.g., miners as discussed in further detail later) may access the entity systems in order to take actions with respect to an event. In other aspects of the invention various systems within an entity may be nodes, which may or may not be grouped together and associated with the entity. In other aspects of the invention, each of the nodes or multiple nodes are maintained by different entities, or components within an entity, and as such different systems within an entity or between entities may act as nodes. As such, the block chain may be controlled by a single entity or multiple entities. A block chain typically works without a central repository or single administrator. One application of a block chain is the public ledger of resource allocations for cryptocurrencies, such as used in bitcoin. In this use of a block chain, the data records recorded in the block chain are enforced cryptographically and stored on the nodes of the block chain.

A block chain provides numerous advantages over traditional databases. For example, with respect to utilizing a block chain for resource allocation information, a large number of nodes of a block chain may reach a consensus regarding the validity of a resource allocation contained on a decentralized resource allocation ledger. Similarly, when multiple versions of a document or resource allocation exits on the ledger, multiple nodes can converge on the most up-to-date version of the resource allocation. For example, in the case of a virtual currency resource allocation, any node within the block chain that stores or validates the resource allocation, can determine within a level of certainty whether the resource allocation can take place and become final by confirming that no conflicting resource allocations (i.e., the same currency unit has not already been spent) are confirmed by the block chain elsewhere on other nodes.

The block chain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria. In some block chain systems, miners are incentivized to create blocks by a rewards structure that offers a pre-defined per-block reward and/or fees offered within the transactions validated themselves. Thus, when a miner successfully validates a transaction on the block chain, the miner may receive rewards and/or fees as an incentive to continue creating new blocks.

As mentioned above and referring to FIG. 2, a block chain 100 is typically decentralized—meaning that a distributed ledger 220 (i.e., a decentralized ledger) is maintained on multiple nodes 210 of the block chain 200. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains.

Various other specific-purpose implementations of block chains may be developed. These include distributed domain name management, decentralized crowd-funding, contract execution, analyst reporting, financial reporting, synchronous/asynchronous communication, decentralized real-time ride sharing, controlling access to or dissemination of timeline, personal, and/or financial data (e.g., a credit report, or the like) and even a general purpose deployment of decentralized applications. As such, block chains may be utilized to access, view, store, create, disseminate, and/or validate any type of event information, or take any other type of action with respect to event information associated with an event.

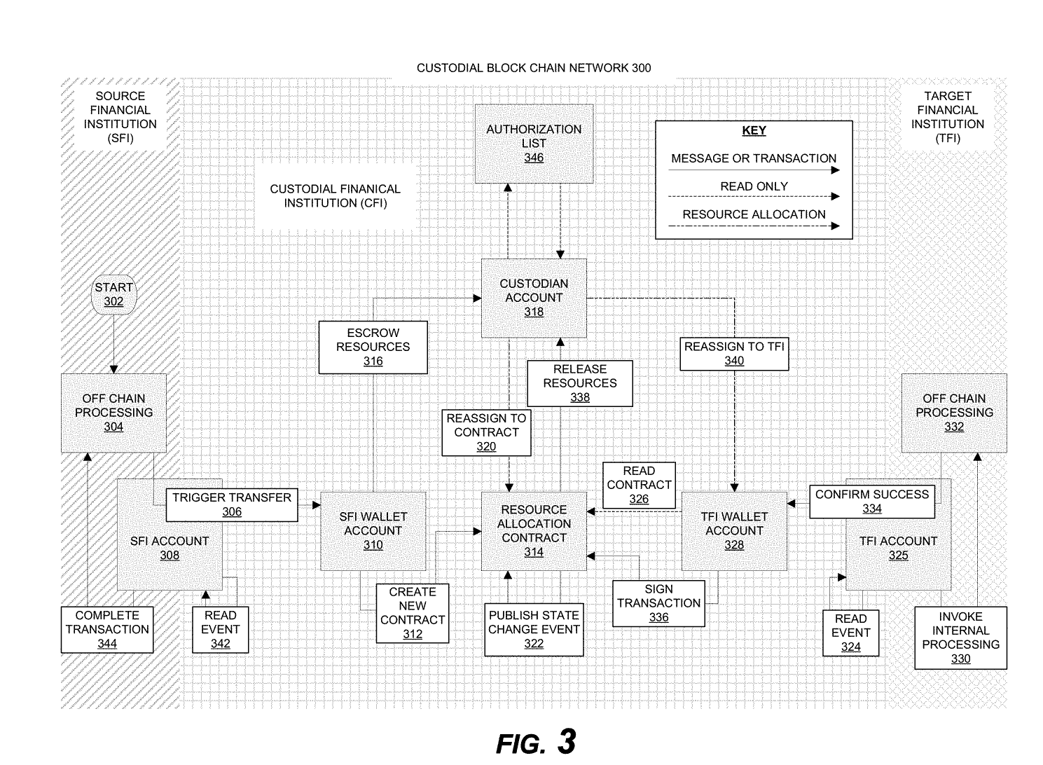

In one embodiment, a block chain may be utilized for resource allocations between a first user 104 associated with a source entity system 140 (e.g., a customer of the source entity system 140) to allocate resources (e.g., in association with a transaction between the users, or businesses associated with the users) to a second user 106 associated with a target entity system 180. As discussed below with respect to FIG. 3, the custodian entity system 190 facilitates the resource allocations and utilizes contracts and block chains to complete the resource allocations.

FIG. 3 presents a flow diagram for completing resource allocation utilizing a custodial block chain network 300, wherein the custodial block chain network 300 can be any combination of systems that utilizes a distributed ledger and/or block chain technology. As illustrated in FIG. 3 at block 302, an allocation of resources process is started by the first user 104 requests an allocation of resources with the source entity system 140 through the use of the first user device 120. In some examples, the request may be a money transfer between two users 104, 106 and as such the source entity is a source financial institution through which the first user 104 has a resource pool, such as an account (e.g., debit account, credit card account, savings account, or the like), and the second user 106 has a resource pool, such as an account (e.g., debit account, credit card account, savings account) with the target entity, which is a target financial institution. In other examples, the request may be a purchase of a good or service (e.g., collectively a “product”) by the first user 104 from the second user 106, wherein the second user 106 is a merchant and the second user 106 has an business account with the target financial institution. These are examples, and it should be understood that the present invention may be utilized with any type of resource allocation, such as stock transfer, asset transfer, real property transfer, or the like.

The request for the resource allocation made by the first user 104 may indicate a first user account associated with the first user 104 from which resources (e.g., funds, assets, or the like) may be allocated. In some embodiments, the first user account from which resources are to be transferred is predetermined by the first user 104, wherein the first user 104 is not prompted to indicate a first user account upon requesting the allocation. In some embodiments of the invention, the first user 104 may request the allocation of resources through an account application 132 (e.g., an online baking application) stored in the memory device 126 of the first user device 120. In other embodiments, the first user 104 may request the allocation of resources at a brick-and-mortar location of the source financial institution. In further embodiments, the first user 104 may request the allocation of resources through a website associated with the source financial institution. In some embodiments of the invention, the first user 104 requests to allocate resources to the second user 106 and/or a second user account associated with the second user 106. In some embodiments, the second user account associated with the second user 106 is held by a different financial institution than that of the source financial institution.

Block 304 of FIG. 3 illustrates how the request for the allocation of resources is processed internally by the source financial institution, apart from the custodian financial institution and/or the block chain. In some embodiments of the invention, the request is processed through a distributed ledger gateway. The distributed ledger gateway is one or more systems and/or applications that allow the source financial institution to integrate with different block chains with multiple entities. As will be discussed in further detail below, the distributed ledger gateway can receive the request for resource allocation from the first user 104 and determine through which block chain the request should be processed.

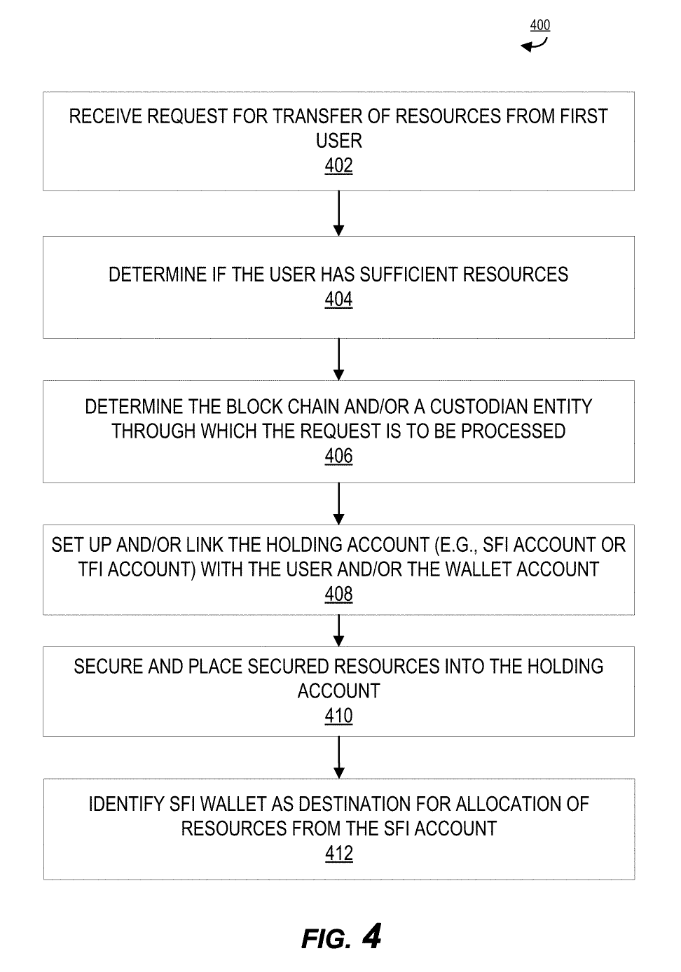

Referring now to FIG. 4, which presents a flow diagram for the off block chain processing carried out internally by a source financial institution 400, block 402 illustrates the initiation of an internal resource allocation process, wherein the source financial institution receives the request for the allocation of resources from the first user account. The request for the allocation of resources may include information related to the second user to which the resources are being allocated, a routing number for the target financial institution, the account number associated with the second user 106, and/or another identifier for identifying the second user 106, a second user account, and/or the target financial institution at which the second user account is located. In some embodiments, the second user 106 may be represented by an alias, and/or the routing number and/or the account number may be an actual routing number and/or account number, or may be an identifier, either of which may be used to indicate through which channels, such as which block chain to process the resource allocation.

At block 404 of FIG. 4, the SFI (e.g., through the source entity system 140) determines if the first user 104 has sufficient resources in order for the SFI to process the request. If the first user 104 does not have sufficient resources, the request may be denied and/or canceled. However, if the first user 104 has sufficient resources, then the process moves to block 406.

Next, block 406 of FIG. 4 illustrates that based on receiving the request for the allocation of resources (and in some cases the indication of sufficient resources), the distributed ledger gateway within the source financial institution determines through which block chain the request should be processed. In the illustrated embodiment, it is determined that the request should be processed through the custodian block chain network 300, as illustrated in FIG. 3. The determination to process the request through a particular custodian block chain network may be based on the target financial institutions (TFIs) that belong to the particular custodian block chain network (e.g., different institutions may belong to different custodian block chain networks). In other aspects of the invention, the nature of the resource transfer (e.g., purchase of a type of product, wire transfer, gift transfer, entities involved such as businesses or individuals, regions, and/or the like) may determine through what custodian block chain network the request is processed. As such, there may be one or more conditions that determine the custodian block chain network through which the request is processed.

Block 408 in FIG. 4 illustrates that after the determination of the block chain through which the resource allocation will occur, the source financial institution sets up a holding resource pool (e.g., a holding account), such as a source financial institution account (“SFI account”) 308 that may be temporarily associated with the first user 104 and/or the first user account, as well as the custodian financial institution and/or block chain through which the resources will be transferred. The SFI account 308 may be a single use account that is deleted after the allocation of the resources are complete. Alternatively, the SFI account 308 is a reassignable account that can be utilized with another future resource allocation after completion of the current resource application.

As illustrated by block 410 the source financial institution system 140 secures the resources from the first user account and transfers them to the SFI account 308 (e.g., the holding account) associated with the first user 104 identified for providing the resources for allocating the resources through the block chain and/or through the custodian financial institution.

In other embodiments of the invention the source financial institution may set up and transfer the resources to the SFI account 308 before a determination of the block chain and/or the custodian financial institution through which the allocation will be made. Thereafter, the source financial institution may associate the funded SFI account 308, or designate the resources therein to the proper custodian financial institution and/or block chain.

Block 412 of FIG. 4 illustrates that the system identifies an SFI wallet account 310 to which the resources from the SFI account 308 will be transferred if the request from the first user 104 is accepted, as will be discussed in further detail later. The resources in the SFI account 308 (e.g., the internal holding account) may be used to fund the SFI wallet 310 within the custodian financial institution. In some embodiments, the resources in the SFI account 308 (e.g., the internal holding account) may be used for transaction balancing or reconciliation of the allocation of resources from the first user account. Off block chain processing may also occur at the target financial institution (TFI) as illustrated by block 332 of FIG. 3, as will be discussed in further detail later.

In some embodiments, processing of the resources in the internal holding account, such as the SFI account 308, may include converting the resources to a currency different than the initial currency of the resources. In some embodiments, the first user 104 request may include a designation that the resources for allocation are initially converted by the system into another currency. In some embodiments, conversion of the currency is performed automatically by the source financial institution system 140 without receiving a request from the first user 104 upon determination that target financial institution account associated with the second user 106 utilizes a different currency.

It should be understood that the off block chain processing described with respect to FIG. 4 was done to hold the source and/or target resources to allow the customer block chain system 300 to process the request. However, it should be further understood that the utilizing the off chain processing may be done for other reasons. For example, the off chain processing, such as the SFI account 308 may be used to allow for the systems to check for potential misappropriation of resources before the contract is accepted by both entities through the SFI account 308. In other examples, the off chain processing may be used in order to determine and/or control the delivery and/or acceptance time of the requests, resources, and/or the contract associated therewith. The determination of the times associated with the events within the systems described herein may help to determine how the requests are processed and/or what entities should receive interest on the resources for holding the resources at different times of the day while the requests are being processed. Additionally, the off chain processing may allow for the disclosure of payments associated with the request before the entities enter into the request (e.g., the contract associated with the quest).

Referring now back to FIG. 3, following the off chain processing performed internally at the SFI, block 306 illustrates an allocation of resources from the SFI account 308 to the SFI wallet account 310 upon the occurrence of the trigger transfer. The trigger transfer may occur before or after the creation and/or acceptance of the contract within the custodian block chain network 300 depending on how the source financial institution (SFI) wants to handle the reconciliation of accounts. It should be understood that the SFI wallet 310, to which the resources from the SFI account 308 are transferred, is a financial account associated with the SFI but maintained by the custodian financial institution (CFI) within the custodial block chain network 300. It should be understood that the SFI may have a single account within the CFI, or the SFI may have multiple accounts within the CFI that may be utilized for the same or different purposes. For example, different wallet accounts of the SFI within the CFI may be used for transfers to or from different regions, based on the size the resource allocation, if entities are participating based on the size of the entities, or the like. However, at least in one embodiment of the invention, the SFI Wallet 310 is a single account through which the SFI makes all of the resource allocations that are processed through the CFI. As resources contained within the SFI wallet 310 on the custodial block chain network are provided and maintained by the SFI, the first user account associated with the first user 104 does not interact directly with the custodian financial institution (CFI), and the block chain associated therewith. Similarly, as discussed in further detail later the target financial institution (TFI) may hold a TFI wallet account 328 with the same custodian financial institution 318 within the custodial block chain network with the same purpose, as will be discussed in further detail below.

In some embodiments, the wallet accounts held by the SFI and TFI at the custodian financial institution are funded with resources by the SFI and TFI, wherein resources are set aside by these financial institutions to fund and maintain the wallet accounts. In some embodiments, the wallet accounts are monitored and updated daily, such as providing resources back to a target level by the end of day operations. In some embodiments, the wallet accounts are updated in response to resources within the accounts falling outside of a predetermined range of values deemed acceptable by the financial institution. In some embodiments, a financial institution may withdraw or reassign resources from the wallet account to another account associated with the financial institution in response to the resources within the wallet account exceeding a predetermined upper limit. In some embodiments, a financial institution may deposit or reassign resources to the wallet account from another account associated with the financial institution in response to the resources within the wallet account falling below a predetermined lower limit.

The custodian financial institution acts as a third party to a resource allocation transaction between the source financial institution and the target financial institution. The custodian financial institution temporarily holds resources (e.g., in an escrow account) involved in an allocation process until a contract (discussed in further detail below) is agreed upon and signed by the parties involved in the transaction. The custodian financial institution may be any financial institution except for the source financial institution and the target financial institution involved in the resource allocation process. In some embodiments, the custodian financial institution may be the Federal Reserve, another bank that is not involved directly in the transaction, or another entity that may be specifically set up to act only as a custodian financial institution.

Block 312 of FIG. 3 illustrates that the as the request for the resource allocation is received by the custodian financial institution, the custodial financial institution system 190 creates a new contract for the resource allocation transaction between the SFI and TFI on the custodial block chain network 300. The resource allocation contract, as illustrated in block 314, is generated by the system and contains the allocation amount, the SFI the TFI, and/or other processing information such as an identifier for the first user and the second user, or an account associated therewith (e.g., real account, or identifier instead of the real account information). In some embodiments, when the allocation contract 314 is created it initially does not have any resources assigned to it. Alternatively, in other embodiments of the invention resources from the SFI wallet 310 may be allocated to the custodian account 318 and assigned to the resource allocation contract 314 when the contract is created.

In some embodiments, the contract 314 is a standard contract that institutions use to allocate resources; however in the present invention the contract is being utilized within a block chain environment, and thus, it may be populated with information that allows for the allocation of the resource, but may keep the identities of the first user and second user, and/or the account information associates with each secret for security purposes. In some embodiments of the invention, the allocation contract 314 is a smart contract. Smart contracts are computer processes that facilitate, verify and/or enforce negotiation and/or performance of a contract between parties. Smart contracts typically include logic that emulates contractual clauses that are partially or fully self-executing and/or self-enforcing.

In some embodiments of the invention, the custodial block chain network 300 (e.g., the CFI system 190, or a representative thereof) may determine that the SFI wallet 310 does not contain the necessary resources to satisfy the contract and may immediately deny or cancel the allocation contract. In other embodiments, the custodial block chain network 300 allows for a period of time for the SFI to provide the necessary resources before canceling the allocation contract upon determining that the SFI wallet 310 is lacking the resources to satisfy the contract. For example, an allocation contract may be generated by the custodian system 190 for an allocation of $50, but the custodian system 190 determines that the SFI wallet 310 only contains $45. In response, the custodian system 190 notifies the SFI of the insufficient resources and allows the SFI a correction time (e.g., 10 seconds, 1 minute, or the like) to provide the necessary resources before the custodian system 190 cancels the allocation contract. In some embodiments, the SFI is triggered to fund the SFI wallet 310 in response to receiving a notification from the custodian system 190 that the SFI wallet 310 contains insufficient resources as required by an allocation contract.

In other embodiments, the SFI may provide the necessary resources to the custodian financial institution in the custodian account 318 to be held for fulfillment of the allocation contract, however the allocation contract is canceled by the system due to a failure associated with the TFI, such as the second user 106 does not exist or the second user account does not exist. In response to the allocation contract being canceled, the system releases the resources held by the custodian account 318, if any, back to the SFI wallet 310 and the resources associated with the first user may be released from the SFI wallet account 310 back to the SFI account 308 associated with the first user.

As illustrated by block 316 of FIG. 3, if there are sufficient resources in the SFI wallet account 310 the resources for the amount required by the allocation contract 314 are released from the SFI wallet account 310 to the custodian account 318. The custodian account 318 temporarily holds the resources until the allocation contract has been signed by the parties involved in the transaction, and the resources are released to the TFI wallet 328 account or to the TFI directly.

As illustrated in block 346, when the contract is created, the custodian financial institution references an authorization list to determine that the financial institutions associated with the contract are authorized to enter into the contract, and thus, are authorized to access the resources being temporarily held by the custodian financial institution for the allocation contract. In other embodiments, the contract may not even be created or may be canceled, if the parties to the contract are not on the authorized user list 346. The system employs the authorization list 346 in order to protect the block chain by prompting entities for identification verification. In some embodiments of the invention, financial institutions are prompted to provide a private key or other form of identification verification for authorization to enter into the contract, accept the contract, and/or access resources held by the custodian financial institution associated with the contract. Alternatively, the financial institutions may be pre-approved and included on the authorization list 346 in order to allow the custodian financial institution to authorize and/or accept the contract when the entities without requiring approval from the SFI or the TFI.

Block 320 of FIG. 3 illustrates that upon receiving the escrowed resources, as required by the allocation contract, from the SFI wallet 310, the custodian system 190 earmarks or otherwise reassigns the escrowed resources from the custodian account 318 to the allocation contract 314. With the resources assigned to the allocation contract 314, the system publishes a state change event to the financial institutions and/or the block chain involved in the transaction, confirming the reassignment of resources to the allocation contract 314 as illustrated in block 322. A contract within the custodial block chain network 300 is referred to as being in different states as it is being processed, and a state change event is a published record of those altered states informing the parties involved in the process. For example, a state change event may chronicle a change to the state of a contract such as an assignment of resources to the contract or an acceptance of the contract by the TFI. The financial institutions are informed of and may track these changes of state in order to determine actions to perform such as, for example, funding or debiting the wallet accounts with the custodian financial institution (i.e., SFI or TFI wallet).

Block 324 of FIG. 3 illustrates that the published state change event of the proposed and funded allocation contract is received by the TFI, wherein the event is read by the TFI associated with the second user 106. Next, block 326 illustrates the TFI reads the allocation contract, allowing the TFI associated with the second user to review, decline or accept the contract, and/or begin off block chain processing of the contract internally at block 330 and 332. The off block chain processing may be the same as or similar to the off block chain processing discussed with respect to the SFI at block 304. As such, the TFI may create a holding account, such as the TF account 325 in order to allow for the acceptance of the resource allocation. However, in other embodiments, it should be understood that the resources may be transferred directly from the TFI wallet 328 to the second user account at the TFI. Additionally, the TFI may confirm acceptance of the contract 334 before signing the allocation contract at block 336. In some embodiments, an action on the contract is taken automatically by the TFI without requiring direct input from the TFI and/or the second user 106.

After the allocation contract has been accepted and signed by the TFI, the target financial institution system 180 transmits a notification to the custodian financial institution system 190 of the acceptance of the allocation contract. As illustrated by block 338 the custodian financial institution system 190 reassigns the temporarily earmarked and/or held resources received from the SFI wallet 310 to the TFI wallet 328. The TFI system 180 may then withdraw the allocated resources in the TFI wallet 328 to the TFI account 325 (e.g., holding resource pool), if it exists, or directly to the second user account associated with the second user 106. In some embodiments of the invention, the allocated resources may be kept in the TFI wallet 328, and the resources are reallocated in the off block chain processing (e.g., the TFI reduces the amount of resources transferred to the TFI wallet 328 during the next funding of the TFI wallet 328 by the amount of resources received from the completion of the contract).

Returning to block 322 of FIG. 3, after the allocation contract has been fulfilled, the system once again publishes a state change event to the financial institutions involved in the transaction and/or to the block chain systems 160. Finally, block 344 illustrates that the resource allocation transaction is completed. In some embodiments, once the resource allocation is completed and the resources have been allocated, the resource allocation is permanent and may not be undone by either party involved in the resource allocation. In some embodiments, the entire process illustrated in FIG. 3 is completed in seconds and/or fractions of seconds.

The custodial block chain network comprises at least a first entity, a second entity, and a custodian entity, wherein the network allows the first entity to quickly, securely, and easily allocate resources associated with a first user, via a contract, from the first entity to a second user associated with a second entity. Both the first and the second entity maintain and periodically replenish resource pools within a third party custodian entity on the block chain who acts as an arbitrator for the allocation of resources by temporarily holding the allocated resources from the first entity while a contract for the allocation is accepted by both the first and the second entity. Upon acceptance of the contract, the resources are released by the custodian entity to the resource pool associated with the second entity allowing the second entity to provide the allocated resource to the second user.

The present invention uses a third party, a block chain, and an electronic contract in order to allow for the resource transfer to occur. Without the use of the off chain processing, the wallet holding accounts (e.g., resource pools) held by the custodian institution, and/or the electronic contract, the processing and allocation of the resource transfers would be nearly impossible, difficult, or to time consuming and/or computer resource intensive to allow the resource allocation to occur using the block chain. This is especially the case when the resource allocation is denied and/or canceled for various reasons because the ability to allocate, hold, and transfer resources within a block chain setting creates a number of issues regarding where the resources are located, if the resources are available (e.g., a user may have the resources before the transfer but they may not when the resources are about to be transferred), when to transfer the resources, and how to account for ownership of the resources. These problems increase when there are multiple entity making millions or billions of resources allocations. By utilizing a custodian entity, wallet accounts (e.g., resource pools), electronic contracts, and/or off chain holding accounts, the resource allocation can be effectively held in escrow until the acceptance of the resource transfer. The present custodian block chain network systems provide improved processing speed, accuracy, and effectiveness of resource transfers between various entities.

It should be understood that the details, status, and/or validation of the contract may be stored on a block chain supported by the CFI, SFI, or TFI, or another institution that is used to validate the contracts for the CFI, SFI, or TFI. It should be understood that depending on how the block chain is set up the various entities described herein may have read, write, and/or read/write access to the block chain in order to validate the transactions occurring over the custodian block chain network 300.

In some embodiments of the invention one or more of the systems described herein may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems, devices, or components thereof described herein. For example, a portion of the block chain application 172 may be stored on the financial institution systems 140, 180, 190, in order to achieve the embodiments of the invention described herein.

It should be understood, that the systems, devices, and components described in FIGS. 1 and 2, or other devices not specifically described herein, may be configured to establish an electronic communications link with each other in order to accomplish the steps of the processes described herein. The link may be an internal link within the same entity (e.g., within the same financial institution for the nodes or components within the nodes) or an external link with the other systems of other entities (e.g., nodes or other systems controlled by other entities). The information within the block chains may be made continuously available, however, continuously available does not necessarily mean that the sources actually continuously generates data, but that a source is continuously available to generate and send data real-time (e.g., instantaneously and/or within a few seconds, or the like) of receiving a request for it. In any case, the sources may be continuously available to receive and/or generate information, in some cases in digitized data in Internet Protocol (IP) packet format.

Moreover, it should be understood that the process flows described herein include transforming the information sent and/or received from the applications of the different systems (e.g., internally or externally) from one or more data formats into a data format associated with the block chain application 172 for use by the one or more entities. There are many ways in which information is converted within the custodial block chain system environment 100 and/or the custodian block chain network 300. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may convert to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

In accordance with embodiments of the invention, the terms “financial institution” and “financial entity” include any organization that processes financial transactions including, but not limited to, banks, credit unions, savings and loan associations, investment companies, stock brokerages, asses management firms, insurance companies and the like. In specific embodiments of the invention, use of the term “bank” is limited to a financial entity in which account-bearing customers conduct financial transactions, such as account deposits, withdrawals, allocations and the like.

In accordance with embodiments of the invention, an “account” is the relationship that a user has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, a non-monetary user profile that includes information associated with the user, or the like. The account is associated with and/or maintained by the entity. The term “resource” or “funds” includes forms of currency or payment stored by a financial institution in an account.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for facilitating electronic resource allocation between a first user associated with a source entity and a second user associated with a target entity through a custodian entity using a custodian block chain network, the system comprising:
one or more memory devices storing computer-readable code; and
one or more processing devices operatively coupled to the one or more memory devices, wherein the one or more processing devices are configured to execute the computer-readable code to:
electronically receive a request from the source entity system through the custodian block chain network to allocate resources from the first user to the second user:
electronically create an electronic contract through the custodian block chain network to allocate the resources from the source entity to the target entity;
electronically store the contract on a block chain through the custodian block chain network;
electronically allocate the resources from a source entity wallet owned by the source entity and held by the custodian entity on a custodian entity system to a custodian wallet through the custodian block chain network;
electronically assign the resources in the custodian wallet to the contract through the custodian block chain network;
electronically store the assignment of the resources to the contract on the block chain through the custodian block chain network;
electronically receive confirmation that the contract is accepted by the target entity through the target entity systems and the source entity system through the source entity system through the custodian block chain network;
electronically store the acceptance of the contract in the block chain through the custodian block chain network;
electronically release the resources from the custodian wallet to the target entity through the block chain network when the contract is accepted; and
electronically store a completion of the contract and resource allocation information regarding the contract in the block chain through the block chain network.

2. The system of claim 1, wherein the one or more processing devices are configured to execute the computer-readable code to create the request by:
electronically receiving the request from a first user through a first user device to allocate the resources from a first user resource pool to a second user resource pool of the second user at the second entity;
electronically determining from the request, the block chain and the custodian entity through which the request should be processed;
electronically creating a source entity holding resource pool that is linked with the first user resource pool and the source entity wallet held by the custodian entity;
electronically securing the resources from the first user resource pool;
electronically allocating the resources from the first user resource pool to the source entity holding resource pool; and
wherein the resources in the source entity holding resource pool are designated for the source wallet held by the custodian resource pool.

3. The system of claim 1, wherein releasing the resources from the custodian wallet to the target entity comprises:
releasing the resources to a target entity wallet linked with the target entity.

4. The system of claim 3, wherein the one or more processing devices are configured to execute the computer-readable code to:
electronically notify the target entity of the contract;
wherein upon acceptance of the contract by the target entity electronically create a target entity holding resource pool that is linked with a second user resource pool and the target entity wallet held by the custodian entity;
electronically receive the resources from the custodian entity wallet in the target entity wallet;
electronically allocate the resources from the target entity wallet to the target entity holding resource pool; and
wherein the resources in the target entity holding resource pool are designated for the second user resource pool at the target entity.

5. The system of claim 3, wherein the one or more processing devices are configured to execute the computer-readable code to:
electronically notify the target entity of the contract;
wherein upon acceptance of the contract by the target entity reconcile the allocation of the resources between the target entity wallet and the second user resource pool at the second entity.

6. The system of claim 1, wherein the one or more processing devices are configured to execute the computer-readable code to:
identify the source entity and the target entity;
access an authorization list with authorized entities;
determine if the source entity and the target entity are authorized entities; and
validate the contract.

7. The system of claim 1, wherein the one or more processing devices are configured to execute the computer-readable code to:
electronically change a contract status of the contract when the contract is created, when the source entity or the target entity are validated, when the resources are assigned by the custodian entity to the contract, when the contract is accepted by the source entity or the target entity, when the resources have been allocated from the source entity to the custodian wallet resource pool or the target wallet resource pool, or when the contract and resource allocation have been validated on the block chain

8. The system of claim 1, wherein the source entity is a source financial institution, the target entity is a target financial institution, and the custodian entity is an entity financial institution, a federal reserve entity, or a specialized entity configured to hold the wallet resource pools.

9. The system of claim 1, wherein the one or more processing devices are configured to execute the computer-readable code to:
electronically monitor the source wallet resource pool or the target wallet resource pool;
determine when resources in the source wallet resource pool or the target wallet resource pool fall below a lower resource amount or increase above an upper resource amount;
electronically transfer new resources to the source wallet resource pool or the target wallet resource pool when the resources fall below the lower resource amount; and
electronically withdrawal a portion of the resources from the source wallet resource pool or the target wallet resource pool when the resources are increased above the upper resource amount.

10. A method for facilitating electronic resource allocation between a first user associated with a source entity and a second user associated with a target entity through a custodian entity using a custodian block chain network, the method comprising:
electronically receiving, by one or more processing devices, a request from the source entity system through the custodian block chain network to allocate resources from the first user to the second user:
electronically creating, by the one or more processing devices, an electronic contract through the custodian block chain network to allocate the resources from the source entity to the target entity;
electronically storing, by the one or more processing devices, the contract on a block chain through the custodian block chain network;
electronically allocating, by the one or more processing devices, the resources from a source entity wallet owned by the source entity and held by the custodian entity on a custodian entity system to a custodian wallet through the custodian block chain network;
electronically assigning, by the one or more processing devices, the resources in the custodian wallet to the contract;
electronically storing, by the one or more processing devices, the assignment of the resources to the contract on the block chain through the custodian block chain network;
electronically receiving, by the one or more processing devices, confirmation that the contract is accepted by the target entity through the target entity system and the source entity system through the source entity system through the custodian block chain network;
electronically releasing, by the one or more processing devices, the resources from the custodian wallet to the target entity through the custodian block chain network when the contract is accepted; and
electronically storing, by the one or more processing devices, a completion of the contract and resource allocation information regarding the contract in the block chain through the custodian block chain network.

11. The method of claim 10, wherein the method further comprises:
electronically receiving, by the one or more processing devices, the request from a first user through a first user device to allocate the resources from a first user resource pool to a second user resource pool of the second user at the second entity;
electronically determining from the request, by the one or more processing devices, the block chain and the custodian entity through which the request should be processed;
electronically creating, by the one or more processing devices, a source entity holding resource pool that is linked with the first user resource pool and the source entity wallet held by the custodian entity;
electronically securing, by the one or more processing devices, the resources from the first user resource pool;
electronically allocating, by the one or more processing devices, the resources from the first user resource pool to the source entity holding resource pool; and
wherein the resources in the source entity holding resource pool are designated for the source wallet held by the custodian resource pool.

12. The method of claim 10, wherein releasing the resources from the custodian wallet to the target entity comprises:
releasing the resources to a target entity wallet linked with the target entity.

13. The method of claim 12, wherein the method further comprises:
electronically notifying, by the one or more processing devices, the target entity of the contract;
wherein upon acceptance of the contract by the target entity electronically creating, by the one or more processing devices, a target entity holding resource pool that is linked with a second user resource pool and the target entity wallet held by the custodian entity;
electronically receiving, by the one or more processing devices, the resources from the custodian entity wallet in the target entity wallet;
electronically allocating, by the one or more processing devices, the resources from the target entity wallet to the target entity holding resource pool; and
wherein the resources in the target entity holding resource pool are designated for the second user resource pool at the target entity.

14. The method of claim 12, further comprising:
electronically notifying, by the one or more processing devices, the target entity of the contract;
wherein upon acceptance of the contract by the target entity, reconciling the allocation of the resources between the target entity wallet and the second user resource pool at the second entity.

15. The method of claim 10, further comprising:
identifying, by the one or more processing devices, the source entity and the target entity;
accessing, by the one or more processing devices, an authorization list with authorized entities;
determining, by the one or more processing devices, if the source entity and the target entity are authorized entities; and
validating, by the one or more processing devices, the contract.

16. The method of claim 10, further comprising:
electronically changing, by one or more processing devices, a contract status of the contract when the contract is created, when the source entity or the target entity are validated, when the resources are assigned by the custodian entity to the contract, when the contract is accepted by the source entity or the target entity, when the resources have been allocated from the source entity to the custodian wallet resource pool or the target wallet resource pool, or when the contract and resource allocation have been validated on the block chain

17. The method of claim 10, wherein the source entity is a source financial institution, the target entity is a target financial institution, and the custodian entity is an entity financial institution, a federal reserve entity, or a specialized entity configured to hold the wallet resource pools.

18. The method of claim 10, further comprising:
electronically monitoring, by the one or more processing devices, the source wallet resource pool or the target wallet resource pool;
determining, by the one or more processing devices, when resources in the source wallet resource pool or the target wallet resource pool fall below a lower resource amount or increase above an upper resource amount;
electronically transferring, by the one or more processing devices, new resources to the source wallet resource pool or the target wallet resource pool when the resources fall below the lower resource amount; and
electronically withdrawing, by the one or more processing devices, a portion of the resources from the source wallet resource pool or the target wallet resource pool when the resources are increased above the upper resource amount.

19. A computer program product for facilitating electronic resource allocation between a first user associated with a source entity and a second user associated with a target entity through a custodian entity using a custodian block chain network, the computer program product comprising at least one non-transitory computer-readable medium having computer-readable program code portions embodied therein, the computer-readable program code portions comprising:
an executable portion configured to electronically receive a request from the source entity system through the custodian block chain network to allocate resources from the first user to the second user:
an executable portion configured to electronically create an electronic contract through the custodian block chain network to allocate the resources from the source entity to the target entity;
an executable portion configured to electronically store the contract on a block chain through the custodian block chain network;
an executable portion configured to electronically allocate the resources from a source entity wallet owned by the source entity and held by the custodian entity on a custodian entity system to a custodian wallet through the custodian block chain network;
an executable portion configured to electronically assign the resources in the custodian wallet to the contract through the custodian block chain network;
an executable portion configured to electronically store the assignment of the resources to the contract on the block chain through the custodian block chain network;
an executable portion configured to electronically receive confirmation that the contract is accepted by the target entity through the target entity systems and the source entity system through the source entity system through the custodian block chain network;
an executable portion configured to electronically release the resources from the custodian wallet to the target entity through the custodian block chain network when the contract is validated and accepted; and
an executable portion configured to electronically store a completion of the contract and resource allocation information regarding the contract in the block chain through the block chain network.

20. The computer program product of claim 19, wherein the computer-readable program code portions further comprise:
an executable portion configured to electronically receiving the request from a first user through a first user device to allocate the resources from a first user resource pool to a second user resource pool of the second user at the second entity;
an executable portion configured to electronically determining from the request the block chain and the custodian entity through which the request should be processed;
an executable portion configured to electronically creating a source entity holding resource pool that is linked with the first user resource pool and the source entity wallet held by the custodian entity;
an executable portion configured to electronically secure the resources from the first user resource pool;
an executable portion configured to electronically allocate the resources from the first user resource pool to the source entity holding resource pool; and
wherein the resources in the source entity holding resource pool are designated for the source wallet held by the custodian resource pool.
